(19) United States
(12) Patent Application Publication
(10) Pub. No.: US 2010/0269705 A1
(43) Pub. Date: Oct. 28, 2010

(54) DEVICE FOR PERFORATING PORTIONED CAPSULES

(76) Inventors: Andrea Zonelli, Marcon (Venezia (IT); Andrea Ferraro, Salgareda (Treviso) (IT)

Correspondence Address: MCGLEW & TUTTLE, PC, P.O. BOX 9227, SCARBOROUGH STATION, SCARBOROUGH, NY, 10510-9227, US

(21) Appl. No.: 12/669,663

(22) PCT Filed: Jul. 18, 2008
(86) PCT No.: PCT/IT08/00487

§ 371 Date: Jun. 14, 2010

(30) Foreign Application Priority Data
Jul. 20, 2007 (IT) MO2007A000241

(51) Int. Cl. A47J 31/40; A47J 31/44

(52) U.S. Cl. 99/295; 99/289 R

(57) ABSTRACT

A device for perforating a capsule (100) containing a soluble or infusion product, which can be associated with a machine (50) for preparing beverages, comprises one body (2), equipped with one first face (3) provided with at least one sharp protrusion (5) suitable to perforate one wall (101) of said capsule (100) in one operating condition (C), and conduit means (8), to bring in communication said first face (3) with one second opposite face (4) of said body (2), said at least one sharp protrusion (5) comprising lateral wall means (6) provided with groove means (7) communicating with said conduit means (8) and arranged in such a way as to connect one inner volume (103) of said capsule (100) to said conduit means (8) in said operating condition (C).

### TECHNICAL FIELD

The present invention relates to automatic machines for preparing beverages, in particular the present invention refers to a device for perforating portioned capsules of an infusion product in a machine for preparing beverages, in particular hot beverages such as coffee, tea, chamomile, etc.

### BACKGROUND ART

Automatic machines for preparing beverages are well known, which uses pods, capsules or cartridges, made for example of plastic, paper or metallic material, containing predetermined doses of coffee or of other infusion product. In these machines, a high temperature liquid, typically water, is introduced under pressure inside the capsule, having a substantially cylindrical shape, through a first wall of the latter, the beverage flowing out from a second wall opposite to the first one. The above mentioned walls are provided with holes or permeable portions in order to allow passage of the water and of the beverage.

The portioned capsule is housed inside an infusion chamber of the machine, which can be generally arranged in an opening position, in order to allow insertion or extraction of the capsule from the machine itself, and in a working position, in which said first wall of the capsule is abutted by a closing wall of the infusion chamber, through which the hot pressurized water passes.

In some embodiments, the infusion chamber is fixed and the closing wall of said chamber moves linearly in order to insert a capsule into, and therefore to close it inside said infusion chamber.

If the portioned capsule is sealed, in order to assure a better preservation of the product contained inside it and a greater hygiene of the process for producing the beverage, perforating means are necessary for perforating the opposite walls of the capsule and for introducing the pressurized hot water inside it, thus allowing outflowing of the beverage.

At this end, a bottom wall of the infusion cylinder is provided with a plurality of hollow projections suitable to perforate the second wall of the capsule. The beverage that is obtained, through solution or infusion of the product contained inside the capsule, penetrates inside the conduits arranged in each hollow protrusion, through the apertures produced by the protrusions in the walls. The conduits of the protrusions communicate with a collecting conduit which directs the beverage towards a dispensing nozzle of the machine.

The configuration of the hollow protrusions must be suitable to assure the tightness with the wall, i.e. to assure that the beverage passes only through the conduits of the protrusions and the collecting conduit. In this way the beverage cannot flow out into the infusion cylinder.

Similarly, the closing wall of the infusion chamber has one or more substantially hollow protrusions, which are suitable to perforate the first wall of the capsule and to convey the water inside it.

For purposes of economy and structural lightness in the production of the coffee machines, a plurality of components thereof, among which in particular the infusion cylinder and the closing piston, are made of plastic material, typically by means of an injection molding process.

A disadvantage of the above mentioned perforating devices for perforating capsules is the fragility of the hollow protrusions, made of plastic material, that under the action of the high temperature pressurized water are subject to break after a relatively low number of working cycles of the machine. The break of a protrusion causes the blockage of the relative conduit in which the water passes and/or the lack of tightness with the wall of the capsule. This results in worse quality of the beverage, due to the fact that not the entire dose of product contained inside the capsule is crossed by the water. Furthermore, a reduction in the dispensed beverage occurs, as a part thereof flows out into the infusion chamber, inside the machine.

This drawbacks force to use perforating elements which are removable from the machine and which can be replaced if required. However, this solution does not prevent a progressive decrease in quality of the beverage and/or a partial outflow of the beverage itself into the infusion cylinder, or the stop of the machine in order to replace the perforating elements. Moreover, the periodical replacement of the perforating elements is expensive.

### SUMMARY OF THE INVENTION

An object of the present invention is to improve the known perforating devices for perforating portioned capsules of a soluble or infusion product, for example coffee, tea, etc., in machines for preparing beverages, in particular hot beverages.

According to some embodiments, an object of the invention is to provide a perforating device, which assures a correct perforation of the capsule and an optimum passage of the water and/or of the beverage, and which has, at the same time, high wear resistance and long duration.

A further object of some embodiments of the invention is to provide a perforating device, which can be produced in a simple and economical manner and which can be mounted easily and quickly on a machine for preparing beverages.

According to the present invention, a perforating device is provided for perforating a capsule containing a soluble or infusion product, which can be associated with a machine for preparing beverages, comprising a body having a first face provided with at least one sharp protrusion suitable to perforate a wall of said capsule in an operating condition, and conduit means forming a fluid communication to bring in communication said first face with a second opposite face of said body, wherein said at least one sharp protrusion comprises a lateral or side wall provided with groove means, in the form of one or more grooves, connected to said conduit means and arranged in such a way as to connect an inner volume of said capsule to said conduit means in said operating condition.

Thanks to the present invention, it is possible to provide a device, which allows a correct perforation of a portioned capsule and an optimum passage of the water and/or beverage, during an operating phase in a machine for preparing beverages, with which said device and said capsule can be associated.

The device comprises, in fact, a plurality of sharp protrusions or points, spaced from each other and distributed on the first face. Each protrusion has a lateral wall provided with a plurality of grooves connected to respective through apertures of the conduit means. In the perforating operating condition each protrusion generates a respective hole in a wall of the capsule, partially penetrating into an inner volume of the latter. Edges of said holes adhere substantially tight to the lateral wall of the protrusions, thanks to the plastic deformation of the material, with which the capsule is made. In this way, the passage of the beverage, coming out from the capsule, can take place only through said grooves connected to the conduit means. Analogously, the above mentioned edges adhere tight to the first face of the device, thus preventing or greatly reducing the diffusion of the beverage outside said conduit means, inside an infusion chamber of said machine.

At the same time, as the protrusions have a substantially solid cross section on the entire extension—the grooves having reduced dimensions and being obtained on the lateral walls—they present high sturdiness and mechanical strength, and they have a duration that is significantly greater than the duration of the substantially hollow protrusions of the known perforating devices.

### BRIEF DESCRIPTION OF THE DRAWINGS

The invention will be better understood in the description below, set forth with reference to the accompanying drawings, which show a non limiting embodiment of the invention, in which:

FIG. 1 shows a plan view of the device for perforating portioned capsules of infusion product, subject of the invention;

FIG. 2 shows a cross section according to the plane II-II in FIG. 1;

FIG. 3 is an enlarged view of a detail of the device of FIG. 1, in which one perforating sharp protrusion is shown;

FIG. 4 is a cross section according to the plane IV-IV of FIG. 3, in which the sharp protrusion is shown in association with a capsule in a perforating operating condition;

FIG. 5 is a partial cross section of a machine for preparing beverages comprising an infusion chamber provided with the perforating device of FIG. 1, and closing means in an opening position for the introduction of a capsule;

FIG. 6 is an enlarged partial cross section of the machine of FIG. 5, in which the infusion chamber contains a capsule and the closing means are in a closing position.

### DETAILED DESCRIPTION OF AN EMBODIMENT OF THE INVENTION

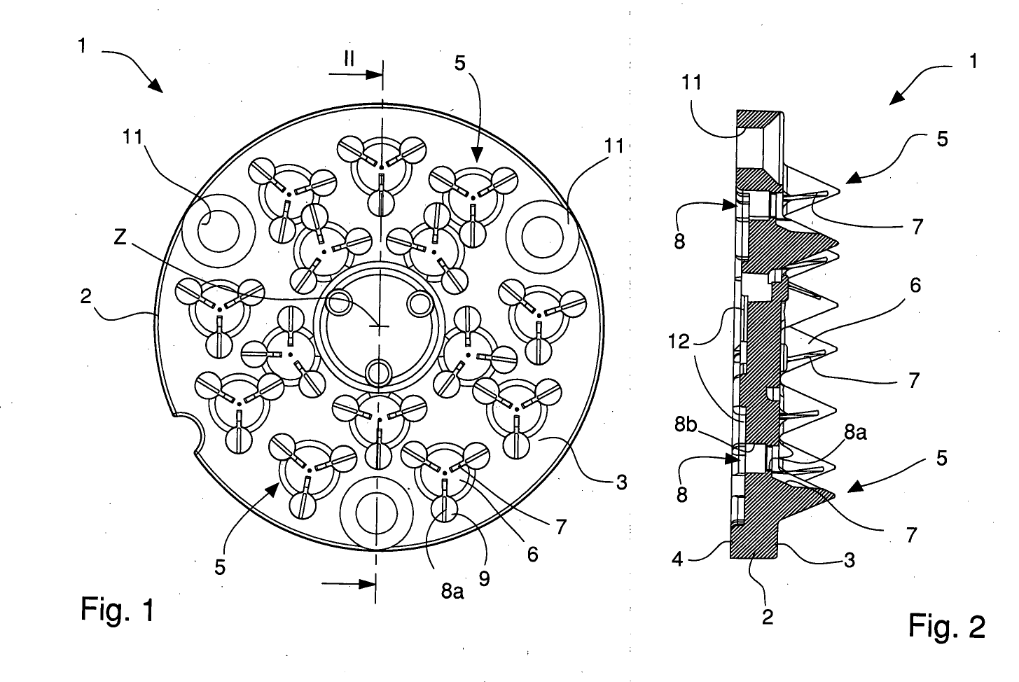

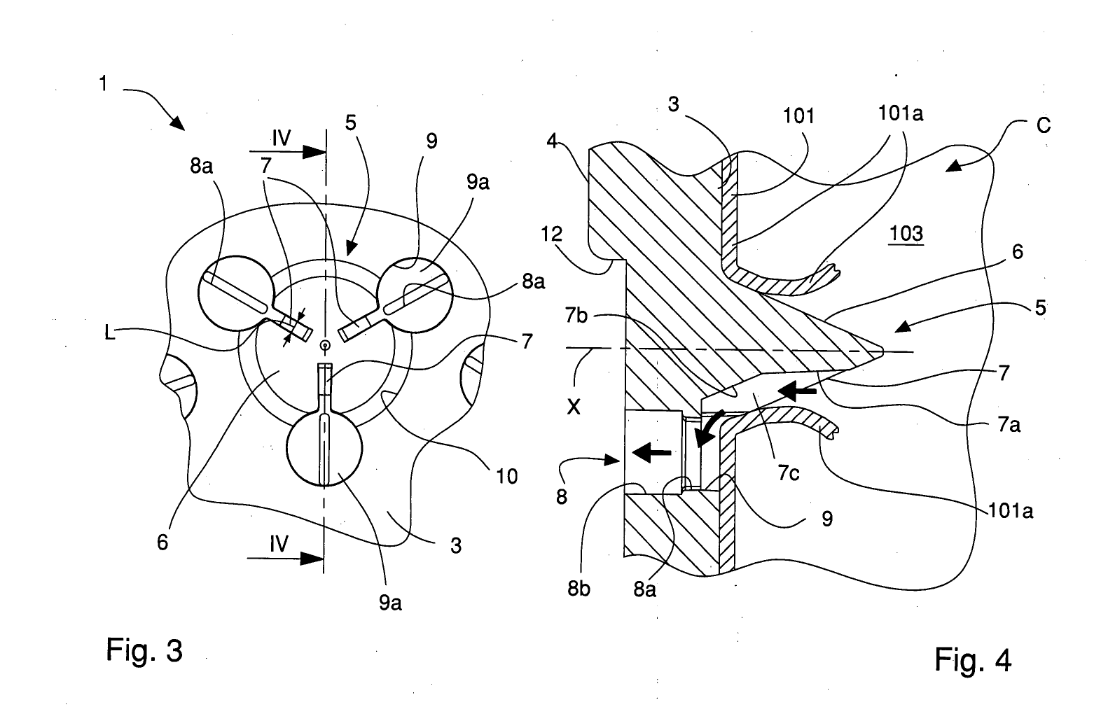

With reference to FIGS. 1 to 6, number 1 indicates a perforating device for perforating a capsule 100 of a soluble or infusion product, which can be associated, with an infusion chamber or cylinder 51 of a machine 50 for preparing beverages, in particular hot beverages such as coffee, tea, chamomile, etc.

The device 1 comprises a substantially flat body 2, for example of substantially circular shape, provided with two faces 3, 4 parallel to each other and mutually opposite.

A first face 3 is provided with one or more sharp perforating protrusions or points 5, suitable to perforate a bottom wall 101 of said capsule 100 in a perforating operating condition C (FIG. 4), explained in more detail in the description below.

The device 1 further comprises conduit means 8, which bring in communication the first face 3 with the second face 4. Said conduit means 8 include any means suitable to establish a fluid communication between the first and the second face of the body 2. In some embodiments said conduit means 8 are in the form of apertures or holes crossing the whole thickness of said body.

In an advantageous embodiment, each protrusion 5 has a solid cross section and a substantially conical or pyramidal shape, with the base positioned on the first face 3, and comprises a lateral wall 6 provided with groove means in the form of one or more grooves 7 connected to said conduit means 8 and arranged in such a way as to connect an inner volume 103 of said capsule 100 to said conduit means 8, in said operating condition C.

Preferably, the groove means comprise one or more grooves 7 arranged angularly spaced on the conical lateral wall 6 of the protrusion 5 and extending substantially along a plane containing the longitudinal axis X of the protrusion, i.e. substantially parallel to a generatrix of said conical lateral wall 6.

In a preferred embodiment, the grooves 7 are, for example, in number of three and they are mutually angularly spaced by 120°.

Advantageously, the groove 7 is delimited, at the sides, by two lateral walls 7c substantially parallel to each other and, at the bottom, by a bottom wall formed by a first portion 7a, substantially parallel to the axis X, and a second portion 7b, substantially parallel to the lateral wall 6.

Each groove 7 has a substantially constant width L.

In a modified embodiment, not shown, the groove 7 comprises a respective substantially concave and arched bottom wall.

In another embodiment of the device, not shown, the groove 7 has a variable width, in particular a width substantially proportional to the distance from said first face 3.

In a further embodiment, not shown, the groove 7 has a substantially variable cross section.

In an advantageous embodiment, not shown, the groove 7 has lateral wall 7c and bottom walls 7a, 7b developed as surface portion obtained from the solution of quadric equation.

The conduit means comprise a plurality of through apertures 8 obtained in the body 2 of the device 1, each through aperture 8 being connected to a respective groove 7 of the protrusions 5.

In particular, each groove 7 terminates in an open cavity 9, for example of circular shape, on a bottom 9a of which is a respective through aperture 8.

In this way, each protrusion 5 is surrounded by three cavities 9, into which respective grooves 7 terminate.

The function of the cavity 9 will be described in detail in the description below.

In one particular embodiment of the device, an annular hollow or channel 10 is also provided in correspondence of the base of each protrusion 5, the hollow or channel connecting the three cavities 9 to each other.

In a modified embodiment of the device 1, not shown in figures, it is provided for the protrusions 5 to have pyramidal shape with polygonal base, for example triangular or square. In this case, the grooves 7 are obtained each on a respective plane face of the lateral wall of said protrusion 5.

Each through aperture 8 comprises a first portion 8a and a second portion 8b. The first portion 8a of the aperture 8 has the shape of an elongated eyelet arranged substantially aligned with the respective groove 7 and terminating on the bottom 9a of the respective cavity 9. The second portion 8b has a substantially cylindrical section connecting the first portion 8a to the second face 4 of the device.

As can be seen in the drawings, each protrusion 5 is provided with a base with which said protrusion is connected to said first face 3 of the body 2. The apertures 8 are designed in such a way as to be arranged on a side of the respective base of the corresponding protrusion. In this way each protrusion 5 can be made solid rather than hollow, as in the prior art perforating devices, except for the very narrow groove or grooves 7. The liquid exiting the cartridge or capsule perforated by the protrusions 5 flows along the grooves 7 and exit the infusion chamber through the apertures 8 arranged sideways with respect to the base of the respective protrusion 5.

In particular, in correspondence of the second face 4 a collecting compartment 12 is provided, in which the second portions 8b of said through apertures 8 terminate, said collecting compartment 12 being arranged in such a way as to abut a seat 59 provided on a bottom wall 53 of the infusion chamber 51.

The perforating protrusions 5 are distributed on the first face 3 around a central axis Z of said device 1, in such a way as to assure a substantially uniform passage of the infusion water, in a working condition of the machine 50.

The device 1 comprises, moreover, a plurality of further apertures 11, mutually angularly spaced with respect to the central axis Z and which are provided to allow said device 1 to be fixed in a removable manner, for example through threaded means, to the bottom wall 53 of the infusion chamber 51 of the coffee machine 50.

With particular reference to FIG. 4, in a perforating operating condition C each perforating protrusion 5 makes a respective hole in the first wall 101 of the capsule 100, partially penetrating into the inner volume 103 of the latter. An edge 101a of said hole adheres in a substantially tight manner to the lateral wall 6 of the protrusion 5, thanks to the plastic deformation of the material, with which the capsule 100 is made. In this way, the passage of the liquid, i.e. of the beverage coming out from the capsule 100, can take place only through the grooves 7 connected to the cavities 9 and the through apertures 8.

In a similar manner, the above mentioned edge 101a adheres in a substantially tight manner to the first face 3 of the device; thus preventing or greatly reducing the diffusion of the liquid outside the cavities 9, which act as collecting wells for collecting said liquid.

In correspondence of the second face 4 of the device 1, the liquid coming out from the apertures 8 is collected in the collecting compartment 12, facing the seat 59 on the bottom wall 53 of the infusion chamber 51, which is connected to a dispensing conduit 58.

In this way, the device 1 assures a correct and optimum outflow of the beverage from the capsule 100 through the grooves 7 and the apertures 8, preventing at the same time irregular and undesired diffusions of said beverage on the first face 3 of the device 1 and inside the infusion chamber 51.

The perforating protrusions 5 of the device 1 thus have a substantially solid cross section on the entire extension along the axis X, this cross section not being substantially reduced or weakened by the grooves 7, which have relatively limited dimensions. For this reason, the perforating protrusions 5 have a great sturdiness and mechanical strength, and have a long duration, significantly greater than the duration of the hollow protrusions of the known perforating devices, even if they are made of plastic material.

Similarly, the through apertures 8 comprise a first portion 8a shaped as an elongated eyelet with reduced dimensions, and they are in greater number than the perforating protrusions 5, in order to give greater sturdiness and stiffness to the body 2 of the device 1, which therefore does not present through holes of great dimensions.

The perforating device 1 is formed in a single piece, for example through injection molding process with, adequate plastic material suitable for food use.

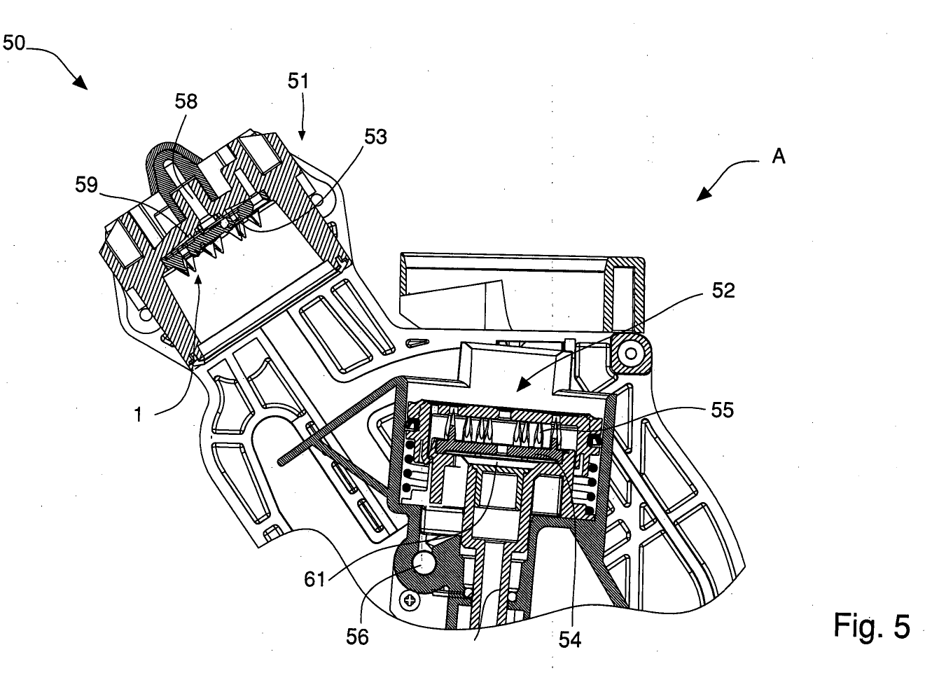

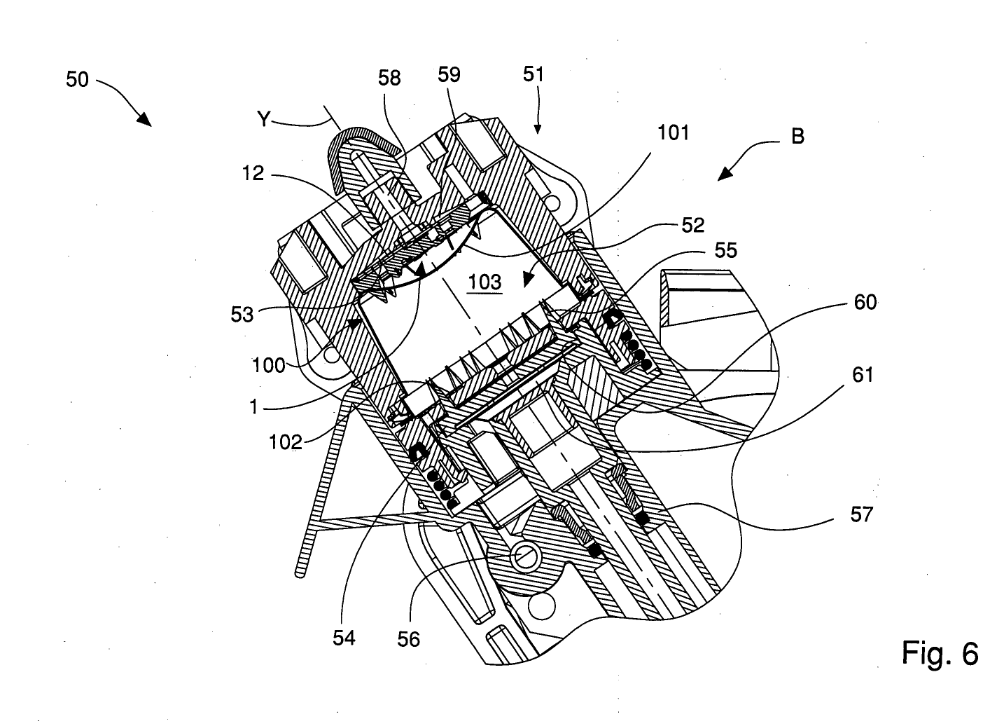

With reference to FIGS. 5 and 6, the machine 50 for preparing beverages is a machine of the known type, comprising closing means 52 including for example a closing piston rotatable around a respective axis between an open position A, in order to allow the introduction of one capsule 100, and a rotated position, in which it is aligned with one infusion chamber 51 provided on the bottom wall 53 of the perforating device 1. In particular, said device 1 is fixed, through threaded fixing means, to said bottom wall 53 in such a way so that its collecting compartment 12 abuts the seat 59 of the latter.

Furthermore, the closing piston 52 is slidable along one respective axis Y in such a way as to insert and close the capsule 100 inside the infusion chamber 51, in a closing condition. B.

In this closing condition B, an outer annular portion of the bottom wall 101 of the capsule 100 abuts the perforating device 1, said bottom wall 101 being introflected, i.e. forming a convexity oriented towards the inner volume 103 of the capsule 100. A further wall 102, opposite to the wall 101, is perforated by further sharp protrusions 55 of a plate 54 inserted in a housing 60 of said closing piston 52 comprising an inlet aperture 61 for the infusion liquid.

The further perforating protrusions 55 are suitable to tear said further wall 102, in order to allow the water to pass without assuring sealing, which is not required due to the fact that the closing piston 52 is crossed only by the infusion water.

The plate 54, in fact, is connected, through the inlet aperture 61, to a supply conduit 56, which is fed through a pump, of the known type and therefore not shown, suitable to feed pressurized hot water from a boiler.

The further protrusions 55 perforate the further wall 102 of the capsule 100, thus allowing the hot water to enter. The pressure of the hot water in the inner volume 103 of the capsule 100 causes the extroversion of the wall 101, which can be therefore perforated by the protrusions 5 of the device 1 in the perforating condition C (FIG. 4).

In a modified embodiment, not shown, the capsule 100 presents a substantially plane wall 101. In this case, the closing condition B and the perforating condition C match to each other, as the compression of the capsule 100 in the infusion chamber 51 by the closing piston 52 causes the simultaneous perforation of the wall 101 and of the further wall 102 by respectively the protrusions 5 and the further protrusions 55.

In another embodiment of the machine 50, not shown in the figures, also the closing piston 42 comprises a perforating device 1, equal to the perforating device mounted on the bottom of the infusion chamber 51 and inserted in the housing 60.

It is understood that the drawing shows just one example, provided merely as a practical demonstration of the invention, which can vary in its forms and arrangements, without however departing from the scope of the concept underlying the invention. Any reference numbers in the appended claims are provided to facilitate reading of the claims with reference to the description and to the drawing, and do not limit the scope of protection represented by the claims.

1. A device for perforating a capsule containing a soluble or infusion product in a machine for preparing beverages, the device comprising:
a body, with a first face provided with at least one sharp protrusion with a lateral wall, said sharp protrusion suitable to perforate a wall of said capsule in an operating condition, and at least one fluid connection, to bring in communication said first face with a second opposite face of said body, said lateral wall being provided with at least one groove connected with said at least one fluid connection and arranged in such a way as to connect an inner volume of said capsule to said fluid connection in said operating condition; and
at least one cavity on said first face interposed between said groove and said at least one fluid connection, said at least one fluid connection comprising at least a through aperture in said body, said through aperture extending between said first face and said second face, said aperture terminating on a bottom surface of said cavity.

2. A device according to claim 1, wherein said sharp protrusion has a substantially solid cross section and a substantially conical or pyramidal shape.

3. A device according to claim 1, wherein said body has a substantially plane shape.

4. A device according to claim 1, wherein said at least one sharp protrusion is provided with a base with which said sharp protrusion is connected to said first face of said body, and wherein said fluid connection is arranged on a side of said base.

5. A device according to claim 1, wherein said at least one groove has a bottom wall which is at least partly substantially parallel to an axis of said sharp protrusion.

6. A device according to claim 1, wherein said at least one groove has a substantially constant width.

7. A device according to claim 1, wherein said at least one groove has a variable width.

8. A device according to claim 7, wherein said at least one groove has a width substantially proportional to a distance from said first face.

9. A device according to claim 1, wherein said groove has a substantially variable cross section.

10. A device according to claim 9, wherein said groove comprises lateral walls and a bottom wall, said walls being developed as surface portions obtained from solutions of quadric equations.

11. A device according to claim 1, wherein:
each sharp protrusion has a plurality of grooves angularly spaced on said lateral wall;
for each sharp protrusion, said fluid connection comprises a plurality of said through apertures, each of said through apertures being connected to one of said grooves;
a plurality of said cavities are provided, each of said cavities being associated with one of said grooves and with one of said apertures, each aperture terminating on a bottom surface of one of said cavities.

12-13. (canceled)

14. A device according to claim 1, wherein each aperture comprises an elongated eyelet arranged substantially aligned to the respective groove.

15-17. (canceled)

18. A device according to claim 16, further comprising a channel arrangement in correspondence of a base of said at least one sharp protrusion and arranged in such a way as to connect said plurality of cavities to one another.

19. A device according to claim 18, wherein said channel arrangement comprises at least a channel with a substantially annular shape.

20. A device according to claim 1, wherein said second face is provided with a collecting compartment whereto said fluid connections terminate.

21. A device according to claim 1, wherein said body comprises a plurality of sharp protrusions arranged and mutually spaced on said first face.

22. A device according to claim 1, further comprising a plurality of further through apertures for fixing said device in a removable manner to a machine for preparing beverages.

23. A device according to claim 1, wherein said body and said at least one sharp protrusion are formed in a single piece, preferably through a molding process.

24. A machine for preparing beverages, in particular hot beverages, the machine comprising:
at least an infusion chamber suitable to receive a capsule of soluble or infusion product and a closing device movable in order to close said capsule inside said infusion chamber and to supply a pressurized liquid for preparing beverages, wherein said infusion chamber is arranged to house on a respective end wall a perforating device for perforating said capsule, said perforating device comprising a body, with a first face provided with at least one sharp protrusion with a lateral wall, said protrusion perforating a wall of said capsule in an operating condition, and at least one fluid connection, to bring in communication said first face with a second opposite face of said body, said lateral wall being provided with at least one groove connected with said at least one fluid connection and arranged in such a way as to connect an inner volume of said capsule to said fluid connection in said operating condition.

25. A machine according to claim 24, wherein said end wall comprises a seat suitable to abut a collecting compartment of said device and connected to a dispensing conduit for dispensing the beverage.

26. A machine according to claim 24, wherein said closing device is provided with a respective perforating device for perforating capsules.

27. A machine according to claim 26, wherein said closing device comprises a housing suitable to receive said respective perforating device and wherein said perforating device is inserted inside said housing in such a way that said collecting compartment faces an inlet aperture of an infusion liquid provided in said housing.

28. (canceled)

29. A beverage production machine, comprising:
a perforation device for perforating a capsule containing at least one product for producing a beverage, wherein said perforation device comprises:
a body with a first face and a second face;
a plurality of sharp protrusions on said first face of said body, each of said sharp protrusions being provided with a side wall;
a plurality of grooves on said side wall of each of said sharp protrusions, each of said grooves being connected with a cavity provided on said first face; and
a through aperture in said body for each said cavity, said through aperture extending from said bottom surface of one of said cavities to said second surface.

30. A beverage production machine comprising a perforation device for perforating a capsule containing at least one product for producing a beverage, the perforation device comprising:
a body comprising a first face and a second face;
a plurality of sharp protrusions on said first face of said body, each of said protrusions being provided with a side wall;
a plurality of fluid connections between said first face and said second face;
at least one groove on said side wall of each of said sharp protrusions, said at least one groove being connected with at least one of said fluid connections;
at least one cavity on said first face, said at least one cavity being interposed between said groove and said at least one of said fluid connections, said at least one of said fluid connections comprising at least a through aperture in said body, said through aperture extending between said first face and said second face, said through aperture terminating on a bottom surface of said at least one cavity.
